(19) United States
(12) Patent Application Publication
(10) Pub. No.: US 2014/0090229 A1
(43) Pub. Date: Apr. 3, 2014

(54) SYSTEM AND METHOD FOR HIGH SPEED FEEDING OF DRIPPER TO IRRIGATION PIPE IN PRODUCTION

(71) Applicant: Shlomo Bloom, Givatayim (IL)

(72) Inventor: Shlomo Bloom, Givatayim (IL)

(21) Appl. No.: 14/123,096

(22) PCT Filed: May 31, 2012
(86) PCT No.: PCT/IL12/50193

§ 371 Date: Nov. 28, 2013

Related U.S. Application Data
(60) Provisional application No. 61/492,422, filed on Jun. 2, 2011.

(51) Int. Cl. B65G 33/04

(52) U.S. Cl. CPC B65G 33/04
USPC 29/428; 29/822; 198/676

(57) ABSTRACT

Device and method are disclosed for feeding drippers into a produced dripping line in speeds as high as 1800-2000 drippers a minute. The drippers are fed into the production line by a cylindrical feeder equipped with a helix worm made on its cylindrical face, which is adapted to engage the helix into a respective recession or protrusion made on a dripper, and to linearly forward it toward a dripping pipe production section while providing accurate control on the speed of movement of the dripper and the spacing between each two consecutive drippers in the produced pipe. The use of a helical worm to engage the drippers provides smooth and gradual mechanical engagement of the feeding device with each dripper, thus ensuring silent and non-vibrating assembly even when in very high production speeds.

### BACKGROUND OF THE INVENTION

Systems and methods for production of dripping irrigation lines using irrigation pipes with internal drippers are know in the art. Typically the drippers are inserted into the produced (i.e. extruded) pipe during the extrusion. The drippers should be installed in a way that will ensure their accurate position in the extruded pipe so that a dripping point in the dripper is accurately positioned against a hole, or punch, in the pipe's wall, to allow proper operation of the dripper. Further, the distance between any two consecutive drippers should be very accurate, in order to provide accurate dripping capacity per area unit per time unit.

Known systems methods for production of dripping irrigation lines are limited in their production speed. FIG. 1A schematically depicts a system for the production of dripper irrigation pipes according to known art. The mechanism for feeding drippers into the system comprise of a belt with protrusions that is designed to push one dripper per each protrusion into the area of pipe production in the machine. This way of feeding of the drippers is inaccurate when production speed goes higher than 800-1000 drippers per minute.

Existing means for inserting a dripper into a produced dripping pipe during its production includes single-sided driving means such as a ribbon with protrusions that are made to linearly push and lead drippers into the produced dripping tube or double-sided means, such as dual driving ribbons (tractor-like) that are made to linearly push and lead drippers into the produced dripping tube.

Another means known in the art for feeding drippers to produced dripping pipe (not shown) may comprise an arrangement of mechanical stoppers that operate synchronously so that train of drippers appearing at the entry of the production plant are separated by two (or more) stoppers operating in synchronous manner, however such arrangement may not exceed production speeds of about 800 drippers per minute without facing severe balancing and noise problems.

FIG. 1B schematically depicts another system for the production of dripper irrigation pipes according to known art. The mechanism for feeding drippers into the system comprise of two feeding belts placed parallel against each other and designed to drag a dripper that was fed to it by the force of friction and feed it into the area of pipe production in the machine. This known in the art system also becomes inaccurate at production rates higher than 800-1000 drippers per minute.

The production speed may be measured by produced length of pipe per time unit or by the number of drippers that are inserted to the produced pipe per time unit. As described above, when the production speed in such production lines exceeds certain limit, for example 800-1000 drippers per minute, the accuracy of the spacing of the drippers, i.e. the distances between consecutive drippers, dramatically deteriorates causing low yield of the product.

### SUMMARY OF THE INVENTION

A system for the production dripping pipe is disclosed comprising a dripper feeding stock unit, a dripper feeding assembly, and a dripping pipe production section having a production direction and production speed. The dripper feeding assembly comprising a dripper feeding device rotatable about a rotation axis comprising, a cylindrical feeder body and at least one helix made on the cylindrical face of said feeder body. The helix may be selected from a protruding helix and a submerged helix. The rotation means are adapted to rotate the dripper feeding device at a controlled speed, to match the feeding speed of drippers to the speed of pipe production.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are illustrations of dripping pipe production systems;

FIG. 2 is an illustration of a dripping pipe production system according to embodiments of the present invention;

FIGS. 3A and 3B depict feeding device in a side view and a top view, respectively, according to embodiments of the present invention;

FIG. 3C depicts a feeding device in a top view, according to embodiments of the present invention;

FIG. 3D depicts a drippers feeding device according to embodiments of the present invention;

FIG. 3E depicts a drippers feeding device in isometric view according to embodiments of the present invention;

FIGS. 3F and 3G which depict partial view of a sharpened tapered tip a of helix of a dripper feeder device in two consecutive feeding steps, according to embodiments of the present invention; and

FIG. 4 is a flow diagram describing a method for feeding drippers according to embodiments of the present invention.

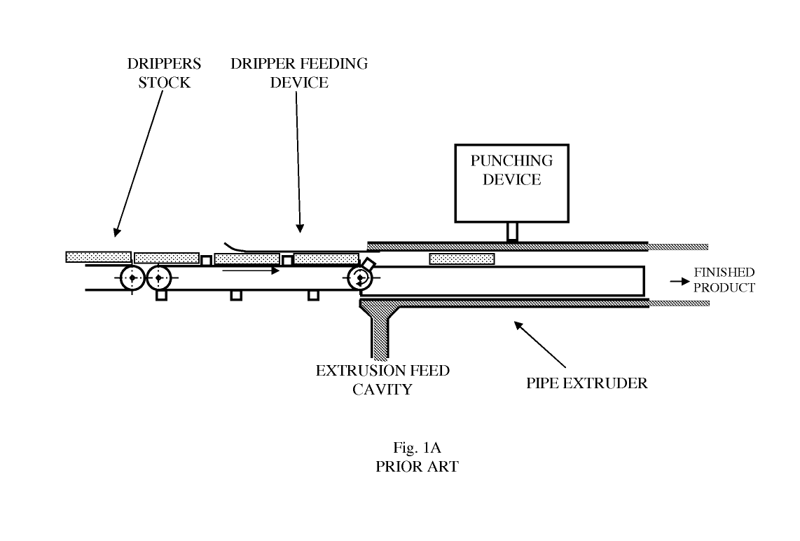

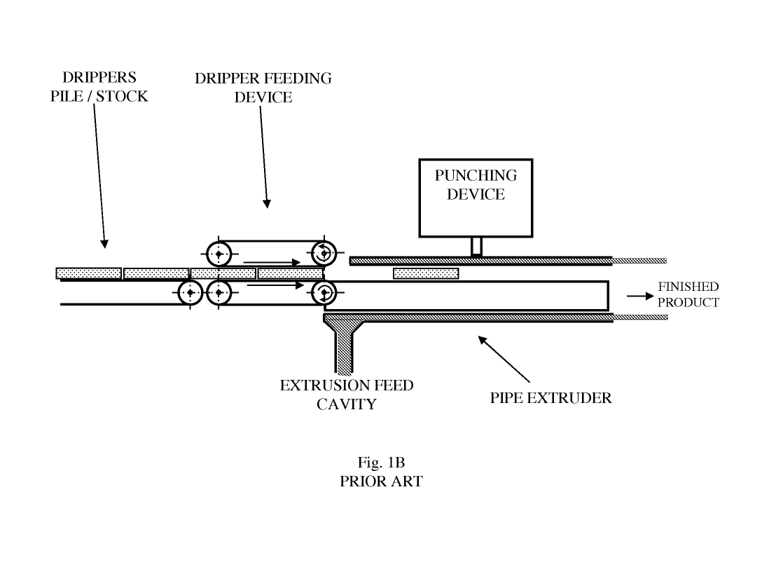

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Means for feeding drippers into the pipe production section of a dripping pipe production machine which can maintain accurate feeding and spacing at production speeds as high as 1800-2000 drippers per minute according to embodiments of the present invention is disclosed. Reference is made now to FIG. 2, which is a schematic illustration of system 10 for the production of dripping irrigation pipe 14 according to embodiments of the present invention. System 10 may comprise pipe production section 12, which may comprise extrusion inlet 15 and pipe forming section 17. Pipe production section 12 further comprises dripper feeding position 13 through which drippers may be fed into the pipe production section, as is known in the art.

System 10 further comprises dripper feeding assembly 40 comprising dripper feeding device 50 and rotation means 55, according to embodiments of the present invention. Dripper feeding device 50 may comprise cylindrical body 53 surrounded by helix worm 52 formed on its cylindrical face. Dripper feeding assembly 40 comprise rotation means 55 coupled to and adapted to rotate dripper feeding device 50 about its longitudinal axis 51. When device 50 turns about axis 51 helix 52 may act as a feeding helical thread and thus, may receive and move a dripper that is in its possession from dripper feeding stock 30 towards pipe production section 12. The exact measurements of the helix (its protrusion from the cylindrical face of the cylinder, its width, its pitch, etc.) may be set according to the specific characteristics of the production line. Rotation means 55 may be realized as an electrical motor, an electrical motor coupled to a speed reduction means such as a gear and the like. According to another embodiment rotation means 55 may be realized by a hydraulic motor, a pneumatic motor and the like. According to yet another embodiment rotation means 55 may be coupled to another section of system 10 and may be motorized from it. The rotation speed of rotation means 55 and dripper feeding device 50 may be controlled to coordinate the feeding speed of dripper feeding device to the speed of production of dripping pipe 14. When rotation means 55 is independent of rotation source from another section in system 10, its speed may be controlled by any known control means such as speed variator, speed control unit and the like (not shown). The actual production speed of pipe production section 12 may be measured by any speed sensor known in the art (not shown) and the measured speed may be provided to the control means of rotation means 55 to be used as a reference for setting of the rotation speed of rotation means 55. When rotation means 55 is mechanically coupled to, and motorized from, for example, the rotation means of pipe production section 12, the speed of dripper feeding device 50 relative to the speed of pipe production section 12 may remain constant by means of the coupling arrangement or may further be controlled independently by the speed control means of rotation means 55.

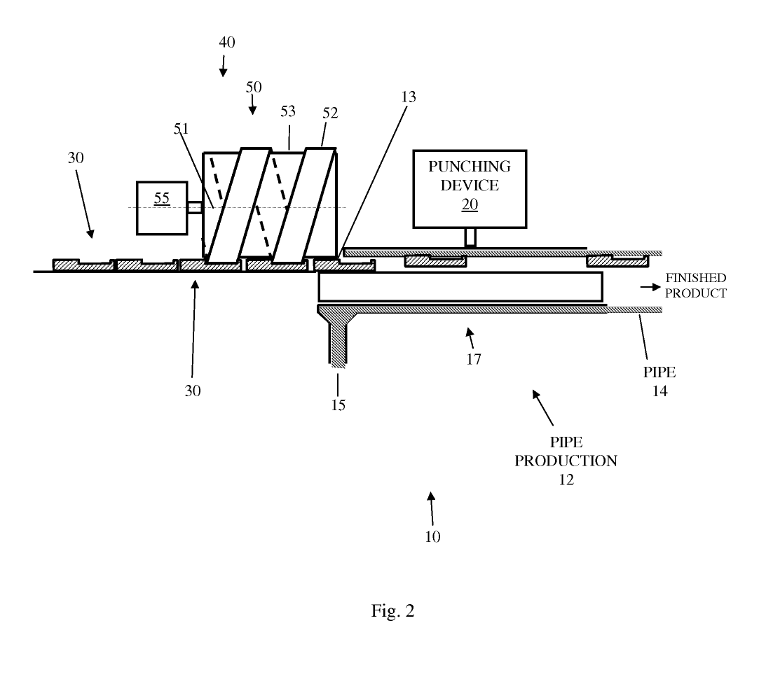

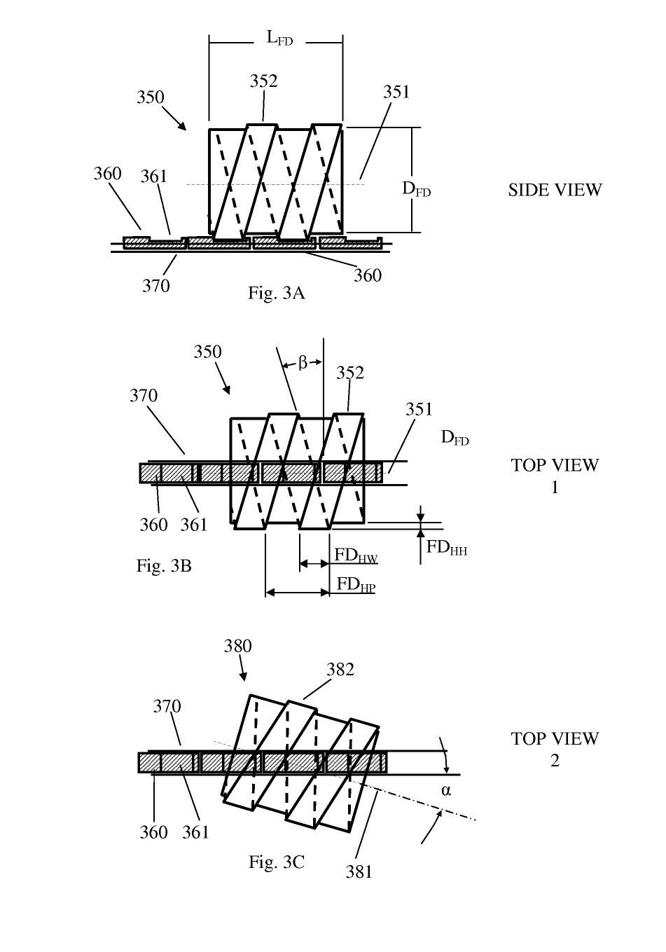

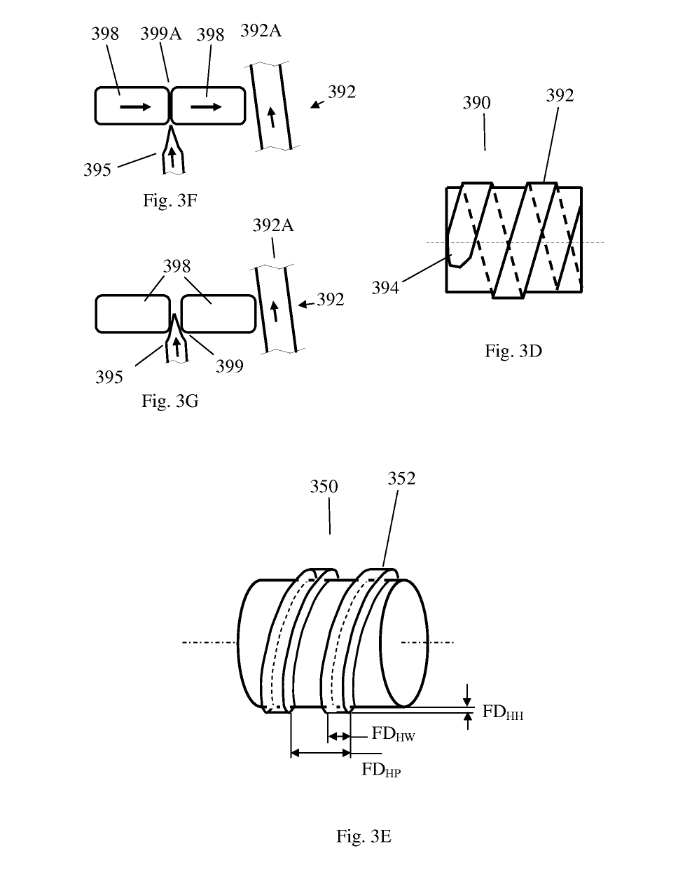

Reference is made now to FIGS. 3A and 3B which depict feeding device 350 in a side view and a top view, respectively and to FIG. 3C which depicts feeding device 380 in a top view, according to embodiments of the present invention. In all these figures feeding devices 350, 380 are drawn as a transparent body, in order to present its positioning with respect to other elements in the drawings, and its functioning with these elements, in a clearer manner. It would be apparent to a person skilled in the art that the transparency of device 350, 380 is not necessarily required according to embodiments of the present invention. Helical protrusions 352, 382 of device 350, 380 are made to fit the specific design of the fed dripper 360 and the requirements of the production line. The example presented in FIGS. 3A, 3B and 3C assume dripper 360 having a relatively flat design with a depression 361 on one of its faces (e.g. the location through which water droplets are designed to emerge from the dripper) as shown in a side view, and substantially rectangular shape as shown in a top view. It would be apparent to one skilled in the art that for enabling dripper feeding device 350, 380 to get hold of a dripper and properly feed it to the production line, according to embodiments of the present invention, dripper 360 may be designed so as to have a protrusion so as to have a protrusion instead of a depression. The embodiments presented in FIGS. 3A, 3B and 3C depict a solution in which feeding device 350, 380 is designed to lead and feed dripper 360 by engaging helix 352, 382 into depression 361 so that when feeding device 350, 380 turns the leading edge of helix 352, 382 touches the inner side of depression 361 and drags dripper 360 with it toward pipe production section 12 (FIG. 2). Drippers that are ready to be inserted into the production line may be stowed in a location near feeding device 350, 380 and be fed towards it using any suitable conveying means, such as dripper conveying rail 370, as is known in the art.

Feeding device 350, 380 may be positioned, with respect to dripper conveying means 370, in one of many possible positions, as may be required according to the specific needs of the production system. For example, turning axis 351, 381 of dripper feeding means 350, 380 may create a desired angle α with the longitudinal direction of conveying means 370. The embodiment in FIG. 3B presents positioning of dripper feeding device 350 so that its turning axis is substantially aligned with the longitudinal dimension of conveying means 370 (angle α equals zero) and as a result angle β by which helix 352 meets dripper 360 (i.e. the angle between a line perpendicular to the turning axis of dripper feeding device 350, 380 and a line tangential to helix 352 at the point where it engages fed dripper 360), is different from zero. The embodiment of FIG. 3C presents positioning of dripper feeding device 350 so that angle α is non-zero and angle β is substantially zero. Design of angle α between feeding device 350, 380 and dripper conveying means 370 may consider the fact that the smaller angle β, the smaller is the negative effect of the impact of feeding device 350, 380 on drippers 360 when the dripper is pulled by the device.

Feeding device 350, 380 may be designed to fit the needs, requirements and design constraints of a specific production line. The design dimensions may include the length L_{FD} and diameter D_{FD} of the cylinder of device 350, 380. The length design may consider the maximum number of drippers to be engaged in helix 352, 382. The diameter of the cylinder may consider the specific design of dripper 360 (how dripper 360 may be engaged with helix 352, 382; what is the design of conveying means 370, etc.). The design of helix 352, 382 parameters width FD_{HW} and protrusion height above the cylindrical face FD_{HH} may take in consideration the specific design of dripper 360 (and how it may be engaged with dripper feeding device 350, 380).

The design of helix 352, 382 pitch FD_{HP} may consider the feeding pace requirements. For example, higher pitch will result higher feeding speed per turn of feeding device 350, 380 and lower pitch will result lower feeding speed per turn of dripper feeding device. Accordingly, dripper feeding device 350, 380 may be designed so that during continuous production it will continuously turn and the accurate adjustment of feeding speed, so as to provide accurate spacing of drippers along a produced dripping pipe 14, will be carried out by relatively small adjustments of the turning speed of dripper feeding device 350, 380. Continuous turning of dripper feeding device 350, 380 is beneficial for example due to smooth operation and lack of impact effects. The pitch of helix 352, 382 may be designed, according to some embodiments, to be at least equal to, or longer than the length of dripper 360. Yet, in other embodiments, depending on the specific design of dripper 360, the pitch of helix 360 may be shorter. In some embodiments two (or more) helixes may be used (not shown), enabling faster feeding speed per turn of feeding device 350, 380.

It shall be noted that the accuracy of placement/insertion of drippers 360 in the produced dripping pipe 14 (i.e. the accuracy of the spacing of the drippers along pipe 14) may also depend on, and be effected by other variables, such as the accuracy/stability of the pipe speed during production—a variable which is independent of the operation of the feeding device. Thus, good enough coordination between the operation of feeding device 350, 380 and the speed of the pipe 14 during production should be guaranteed. It will also be noted that the operation of a punching device, such as punching device 20 (FIG. 2) is typically coordinated with the location of the dripper in the produced pipe 14 independently of the operation of feeding device 350, 380.

Reference is made now to FIG. 3D, which schematically depicts drippers feeding device 390, according to embodiments of the present invention. Feeding device 390 may be designed and made similarly to feeding devices 350 and 380 with helix 392 similar to helix 352 and 382 however in order to ensure smooth engagement of helix 392 with a to-be-fed dripper, its leading thread tip 394 may have a tapered end as shown in the drawing. Tapered end of tip 394 of helix 392 may be designed with taper angle sharp enough to allow penetration of the tip between two consecutive drippers that are fed substantially close to each other, as shown schematically in FIGS. 3F and 3G to which reference is now made. FIGS. 3F and 3G depict partial view of a sharpened tapered tip 395 of helix 392 of a dripper feeder device, as may be seen at a level directly beneath the cylindrical face of dripper feeding device 390, in two consecutive steps of feeding a dripper, according to embodiments of the present invention, in two consecutive steps of engaging dripper 398 from a feeding unit (not shown). Drippers 398 are shown on the feeding unit. Also shown sharpened tapered tip 395 of helix 392 and a part of the adjacent winding 392A of helix 392. Drippers 398 may have rounded edges 399, forming, when two consecutive drippers are close to each other, a firth like space 399A between two consecutive rounded corners 399. A specially sharpened tapered tip 395 of a dripper feeding device, such as device 390, moves in the direction of the arrow drawn on it and, when getting close to firth 399A it may gently penetrate and get apart the consecutive drippers 398, as shown in FIG. 3G. When the penetration of tip 395 completes the frontal dripper locates between helix winding continuing tapered tip 395 and adjacent winding 392A. This configuration allows smooth feeding of drippers regardless of the specific design of the face of the drippers.

Reference is made now to FIG. 3E, which depicts drippers feeding device 350 in isometric view according to embodiments of the present invention. Some of feeding device 350 parameters, such as helix pitch FD_{HP}, helix width FD_{HW} and helix height FD_{HH} are presented in a 3D view.

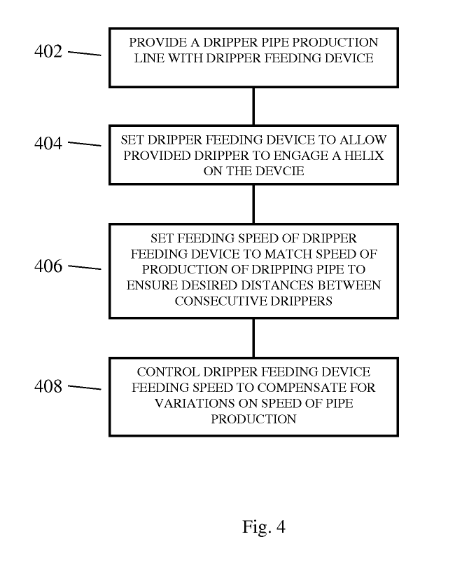

Reference is made now to FIG. 4, which is a flow diagram describing a method for feeding drippers according to embodiments of the present invention. A dripper feeding device according to embodiments of the present invention is installed at a drippers feeding location on a dripping pipe production line (block 402). Setting a dripped feeding device in a location and orientation with respect to a dripping pipe production section to allow provided drippers to engage a helix worm made on said dripper feeding device when it turns (block 404). The feeding speed of the dripper feeding device is set to match the speed of the production of the dripping pipe so that the distances between any desired consecutive drippers is as required (block 406). During continuous production the speed of the dripper feeding device is controlled to compensate for occasional variations in the speed of production of the dripping pipe (block 408).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A dripper feeding assembly for feeding drippers to a dripping pipe production line having a production direction and production speed, comprising:
a dripper feeding device rotatable about a rotation axis comprising:
a cylindrical feeder body; and
at least one helix made on the cylindrical face of said feeder body;
wherein said helix is selected from a group comprising protruding helix and submerged helix, and
rotation means to rotate said dripper feeding device at a controlled speed.

2. The dripper feeding assembly of claim 1 wherein the leading tip of said helix is tapered.

3. The dripper feeding assembly of claim 1 wherein said rotation axis of said dripper feeding device is aligned with said production line direction.

4. The dripper feeding assembly of claim 1 wherein said rotation axis of said dripper feeding device is inclined with respect to said production line direction.

5. The dripper feeding assembly of claim 1 wherein said controlled speed of said rotation means is responsive to indication of said production speed.

6. A system for the production dripping pipe comprising:
dripper feeding stock unit;
dripper feeding assembly comprising:
a dripper feeding device rotatable about a rotation axis comprising:
a cylindrical feeder body; and
at least one helix made on the cylindrical face of said feeder body;
wherein said helix is selected from a group comprising protruding helix and submerged helix, and
rotation means to rotate said dripper feeding device at a controlled speed, and
dripping pipe production section having a production direction and production speed.

7. The system of claim 6 wherein the leading tip of said helix is tapered.

8. The system of claim 6 wherein said rotation axis of said dripper feeding device is aligned with said production line direction.

9. The system of claim 6 wherein said controlled speed of said rotation means is responsive to indication of said production speed.

10. A method for producing dripping pipe comprising:
providing a dripping pipe production section;
setting a dripped feeding device in a location and orientation with respect to a dripping pipe production section to allow provided drippers to engage a helix worm made on said dripper feeding device when it turns;
setting the rotation speed of said dripper feeding device so that the speed of drippers provided by it match a speed of said dripping pipe production unit;
controlling continuously the rotation speed of said dripper feeding device to compensate for variations in the production sped of said dripping pipe production section.
